(19) United States
(12) Patent Application Publication
(10) Pub. No.: US 2013/0321322 A1
(43) Pub. Date: Dec. 5, 2013

(54) MOBILE TERMINAL AND METHOD OF CONTROLLING THE SAME

(71) Applicants: Younghwan Kim, Seoul (KR); Dongsoo Shin, Seoul (KR); Manho Lee, Seoul (KR)

(72) Inventors: Younghwan Kim, Seoul (KR); Dongsoo Shin, Seoul (KR); Manho Lee, Seoul (KR)

(73) Assignee: LG ELECTRONICS INC., Seoul (KR)

(21) Appl. No.: 14/000,355

(22) PCT Filed: Feb. 25, 2011
(86) PCT No.: PCT/KR11/01338

§ 371 Date: Aug. 19, 2013

(51) Int. Cl. G06F 3/041

(52) U.S. Cl. CPC G06F 3/0416
USPC 345/173

(57) ABSTRACT

Disclosed are a mobile terminal and a method of controlling the same. The mobile terminal includes a touch screen acquiring a touch signal regarding at least one region, and a controller selectively executing a function corresponding to a valid touch signal of the acquired touch signal, the valid touch signal having a touch intensity equal to or greater than a preset critical value, on the basis of an increment rate of the touch intensity of the valid touch signal. Since the function is executed on the basis of the increment rate of the touch intensity, a function corresponding to a user's intentional touch may be executed.

### TECHNICAL FIELD

The present invention relates to a mobile terminal and a method of controlling the same, and more particularly, to a mobile terminal capable of executing a function corresponding to a user's intentional touch, and a method of controlling the same.

### BACKGROUND ART

As terminals such as personal computers, laptop computers, cellular phones and the like have become multi-functional, the terminals are being implemented in the form of multimedia devices (players) equipped with a combination of various functions of, for example, capturing still photos or videos, playing music or video files, providing game services, receiving broadcasting signals, and the like.

The terminals may be classified into mobile terminals and stationary terminals according to their portability thereof. The mobile terminals may be divided into handheld terminals and vehicle mount terminals according to whether the terminals are intended to be carried directly by users.

To support and enhance the functions of terminals, the structural and/or software improvement of the terminals may be taken into consideration.

Recently, various terminals including mobile terminals have become multi-functional.

### DISCLOSURE OF INVENTION

### Technical Problem

An object of the present invention is to provide a mobile terminal capable of performing a function corresponding to a user's intentional touch by executing the function on the basis of an increment rate of touch intensity, and a method of controlling the same.

The object of the present invention is not limited to the aforesaid, but other objects not described herein will be clearly understood by those skilled in the art from descriptions below.

### Solution to Problem

To accomplish the objects of the present invention, according to an aspect of the present invention, there is provided a mobile terminal including a touch screen acquiring a touch signal regarding one region; and a controller selectively executing a function corresponding to a valid touch signal of the acquired touch signal, the valid touch signal having a touch intensity equal to or greater than a set critical value, on the basis of an increment rate of the touch intensity of the valid touch signal.

To accomplish the objects of the present invention, according to another aspect of the present invention, there is provided a method of controlling a mobile terminal, including: acquiring a touch signal regarding at least one region; and executing a function corresponding to a valid touch signal of the acquired touch signal, the valid touch signal having a touch intensity equal to or greater than a set critical value, wherein the executing of the function is selectively executed on the basis of an increment rate of the touch intensity of the valid touch signal.

To accomplish the objects of the present invention, according to another aspect of the present invention, there is provided a method of controlling a mobile terminal, including: acquiring first and second touch signals regarding different positions; and outputting, as a valid touch signal, a touch signal of the first and second touch signals, having a touch intensity equal to or greater than a set critical value while an increment rate of the touch strength is equal to or greater than a reference increment rate.

### Advantageous Effects of Invention

According to a mobile terminal and a method of controlling the same according to exemplary embodiments of the present invention, a function is executed on the basis of an increment rate of touch intensity, so that a function corresponding to a user's intentional touch can be executed.

### BRIEF DESCRIPTION OF DRAWINGS

FIG. 1 is a perspective view illustrating a mobile terminal according to an exemplary embodiment of the present invention.

FIG. 2 is a block diagram of the mobile terminal of FIG. 1.

FIG. 3 is a conceptual view illustrating an operation related to a touch input of the mobile terminal of FIG. 2.

FIGS. 4A through 6 are views illustrating one example of a touch input on a virtual key depicted in FIG. 3.

FIG. 7 is a flowchart of operational processes of the mobile terminal of FIG. 1.

FIG. 8 is a view illustrating a user's touch on the mobile terminal of FIG. 1.

FIGS. 9A through 10B are views illustrating how the touch depicted in FIG. 8 proceeds.

FIGS. 11 and 12 are graphs showing an increase in touch points according to the progress of the touch shown in FIGS. 9A through 10B.

FIG. 13 is a graph showing an increase in touch points according to another exemplary embodiment of the present invention.

FIGS. 14 through 16 are views illustrating a touch according to still another exemplary embodiment of the present invention.

FIGS. 17 through 19 are views illustrating a touch according to another exemplary embodiment of the present invention.

FIG. 20 is a view illustrating a touch according to still another exemplary embodiment of the present invention.

### MODE FOR THE INVENTION

Exemplary embodiments of the present invention will be described below in more detail with reference to the accompanying drawings. The objects, features and effects of the present invention will be readily understood through embodiments related to the accompanying drawings. The same reference numerals will be used throughout to designate the same or like components. Moreover, detailed descriptions related to well-known functions or configurations will be ruled out in order not to unnecessarily obscure subject matters of the present invention.

Description will now be given in detail of exemplary configurations of mobile terminals according to the present invention, with reference to the accompanying drawings. Hereinafter, the terms “moodule”,? “unit”,? or “portion” ? for components are merely provided for facilitating explanation of the present invention, and thus they are not provided a specific meaning or function. Hence, it should be noticed that “moodule”,? “unit”,? or “portion” can be used interchangeably.

The mobile terminals described in the following description may be implemented as different types of terminals, such as mobile phones, smart phones, notebook computers, digital broadcast terminals, personal digital assistants (PDA), portable multimedia players (PMP), navigators, and the like.

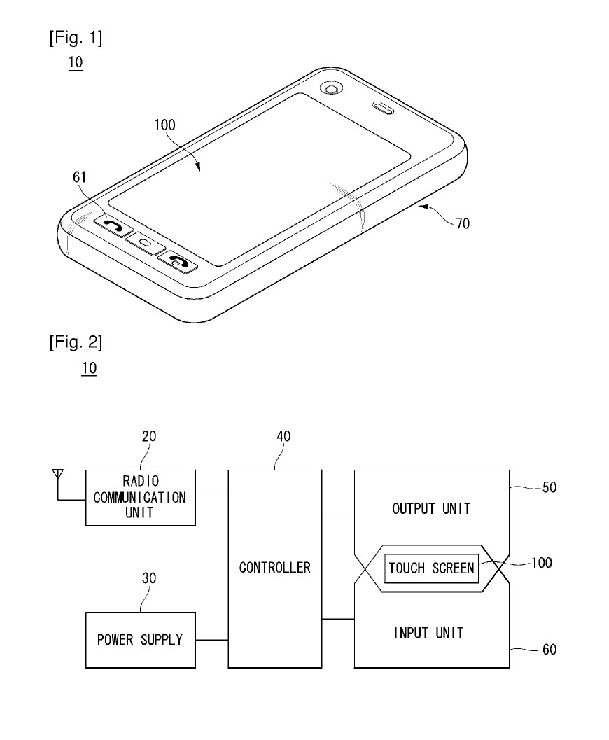

FIG. 1 is a perspective view illustrating a mobile terminal according to an exemplary embodiment of the present invention.

As shown therein, a mobile terminal 10, according to an exemplary embodiment of the present invention, may include a body 70, input keys 61 and a touch screen 100.

The body 70 constitutes the exterior of the mobile terminal 10. The body 70 may be formed by the coupling of a front body and a rear body. The body 70 protects the internal components of the mobile terminal 10, such as a controller 40 (see FIG. 2), from external shock or the like. Furthermore, to ensure sufficient emotional quality, the body 70 may be subjected to a surface-treatment, decoration or the like through a variety of post-processing. In the drawing, the body 70 is illustrated as a bar shape; however, various modifications into slid, folder, swing, swivel type shapes for example may be made.

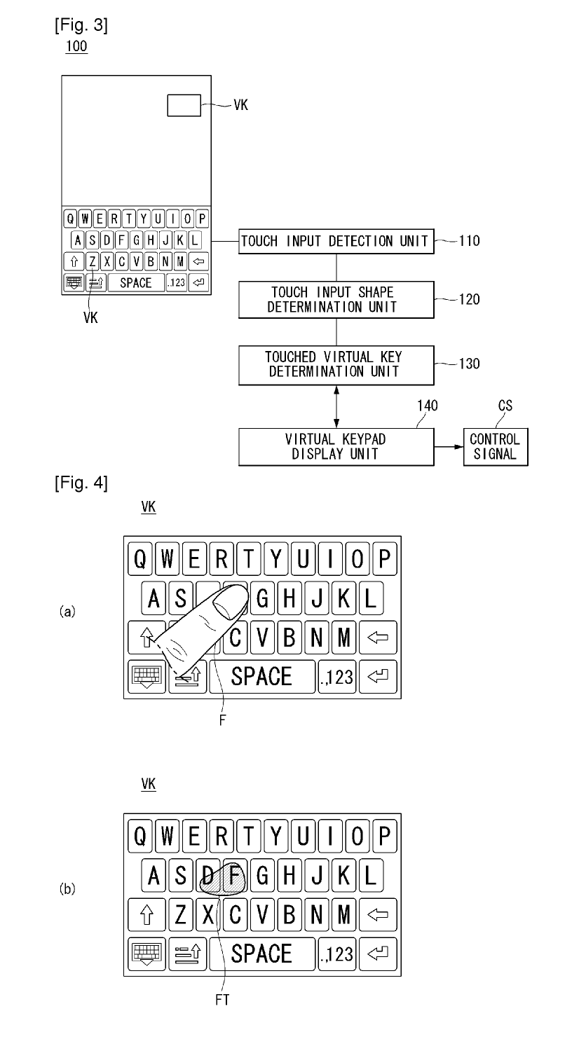

The input keys 61 may be physical buttons corresponding to respective functions, such as calling, call cancellation or call termination or the like. As occasion demands, the body 70 may be provided with a virtual keypad VK (see FIG. 3) being displayed on the touch screen 100, instead of the input keys 61. A detailed description of the virtual keypad VK (see FIG. 3) will be described later.

FIG. 2 is a block diagram of the mobile terminal of FIG. 1.

As shown in the drawing, the mobile terminal 10 according to an exemplary embodiment of the present invention may include a radio communication unit 20, an input unit 60, an output unit 50, a controller 40, a power supply 30, and the touch screen 100.

The radio communication unit 20 may include at least one module that enables radio communication between the mobile terminal 10 and a radio communication system or between the mobile terminal 10 and a network in which the mobile terminal 10 is located. For example, the radio communication unit 20 may include a broadcasting receiving module, a mobile communication module, a wireless Internet module, a local area communication module and a position information module.

The input unit 60 generates input data from a user for the operational control upon the mobile terminal 10. The input unit 60 may be configured as a keypad, a dome switch, a jog wheel, a jog switch or the like, besides a resistive or capacitive touch pad 62 shown in the drawing.

The output unit 150 generates visual, auditory or tactile output and may include an audio output module, an alarm and a haptic module or the like, as well as the touch screen 100 depicted in the drawing.

In general, the controller 40 controls the overall operation of the mobile terminal 10. For example, the controller 40 may provide control and processing for voice communication, data communication, video communication or the like. The controller 40 may be provided with a multimedia module for a multimedia playback. The controller 40 may perform pattern recognition so as to recognize a writing input or a drawing input, made on the touch screen 100, as a letter and an image.

The power supply 30 receives external power or internal power by control of the controller 40 and supplies power required for the operation of each component.

The touch screen 100 may be configured to occupy a large part of the front surface of the body 70 (see FIG. 1). The touch screen 100 may display a variety of information and may allow a user to select a specific piece of information. The touch screen 100 may be provided in the form of a combination of a display panel and a touch panel. This means that the touch screen 100 may be configured by bonding a touch panel, capable of receiving a touch input, with a display panel such as a liquid crystal display (LCD), an organic light-emitting diode (OLED) or the like. Furthermore, the touch screen 100 may be produced by integrating the display panel and the touch panel with each other. The touch panel may be configured into a resistive type, capacitive type, an infrared type, an ultrasonic type or the like. Among those types of touch panel, the capacity type is associated with recognizing a touch input by detecting a variation in capacitance between conductive layers included in the touch panel. Although not shown specifically in the drawing, the capacitive type touch panel includes two conductive layers, a single insulating substrate, and a protection layer, and a shield layer may be added thereto in order to increase a signal-to-noise ratio.

The touch screen 100 may be considered to act as both the output unit 50 and the input unit 60 in that the touch screen 110 includes the display panel displaying an image and the touch panel receiving a touch input. That is, the touch screen 100 serves as the output unit 50 by displaying a virtual keypad VK (see FIG. 3) thereon while serving as the input unit 60 by receiving a touch input through the displayed virtual keypad VK (see FIG. 3).

FIG. 3 is a conceptual view illustrating the operation related to a touch input on the touch screen of FIG. 2.

As shown in the drawing, the touch screen 100 according to an exemplary embodiment of the present invention may be divided into two regions. That is, a key value display part KP may be displayed on the upper part of the touch screen 100, and the virtual keypad VK receiving a key input through a touch (contact) may be displayed on the lower part of the touch screen 100.

The virtual keypad VK may be displayed in the form of a QWERTY keypad or the like. Of course, the virtual keypad VK is not limited to the description, and may be modified variously as occasion demands. Furthermore, the virtual keypad VK is not limited to a display for inducing the input of letters. That is, the virtual keypad VK may be displayed as various icons or various characters implemented in various games and capable of receiving a touch input. For example, in the case where a chess game is displayed on the touch screen 100, the virtual keypad VK may be displayed as chessmen on a chessboard. As described above, the virtual keypad VK may be implemented in various forms; however, according to an exemplary embodiment of the present invention, the virtual keypad VK will be described as a QWERTY keypad. When a touch input occurs on the virtual keypad VK, a touch input detection unit 110 detects the touch input.

The touch input detection unit 110 may detect a touch signal generated at a touch sensing node (an intersection of H and V in FIG. 6). That is, when a user touches the virtual keypad VK, a touch signal is generated at a touch sensing node (e.g., the intersection of H and V in FIG. 6) adjacent to a touched portion, and the touch input detection unit 110 may detect the touched point of the touch screen 100 and the touch intensity at each touch sensing node (e.g., each intersection of H and K in FIG. 6) on the basis of the generated touch signal.

A touch input shape determination unit 120 may determine the shape of a region in which the touch input has been made, on the basis of the touch signal detected by the touch input detection unit 110. Typically, a touch on the touch screen 100 is made with the finger or the like. Thus, when a user touches the touch screen 100, the touched portion is not a dot but a surface. In this case, the touch input shape determination unit 120 determines the shape of the surface on which the touch occurs. The operational method of the touch input shape determination unit 120, determining the shape of a surface, will be described later in more detail.

A touched virtual key determination unit 130 determines a key that is estimated to be one that the user who has touched the touch screen 100 actually intended to touch, on the basis of the shape of the surface of the touch obtained by the operation of the touch input shape determination unit 120. A key, estimated to be actually desired by the user, may be determined on the basis of a priority value and the shape of a touched region according to a general touch habit of a typical user. After the touched virtual key determination unit 130 determines the key, a result of the determination may be output as a control signal CS, A detailed description of the operational method of the touched virtual key determination unit 130 will be made later.

A virtual keypad display unit 140 displays the virtual keypad VK on the touch screen 100. The virtual keypad display unit 140 may transmit information regarding the displayed virtual keypad VK to the touched virtual key determination unit 130. The information regarding the displayed virtual keypad VK may contain information regarding the position of each key. The touched virtual key determination unit 130 may refer to the information regarding the virtual keypad VK, received from the virtual keypad display unit 140, in determining a key estimated to be actually desired by a user.

FIG. 4A through FIG. 6 are views illustrating one example of a touch input on the virtual keypad of FIG. 3.

As shown in FIG. 4A, a user may touch the virtual keypad VK by using the tip of the finger F. When the user touches a virtual key of the virtual keypad VK, two or more virtual keys may be touched at the same time due to various reasons such as the wider tip of the finger F touching the virtual keypad VK than a single virtual key or a slanted finger position on the virtual keypad VK.

FIG. 4B illustrates the case in which a user touches a plurality of virtual keys of the virtual keypad VK due to the above-described reason. A closed curve of a touch (hereinafter, a closed touch curve) FT, drawn along the outer edge of the shape of the touch according to an area touched by the user, may overlay the D key and the F key of the virtual keypad VK. According to the related art in which a touch input is recognized merely based on a coordinate value, when a touch input is made over a plurality of virtual keys of the virtual keypad VK, various key values may be output depending on the circumstances. For example, it may be recognized that the D key initially touched by the finger F is input, the D key and the F key are input sequentially with a small time interval, or the F button touched afterwards is input. According to an exemplary embodiment of the present invention, even when a plurality of virtual keys of the virtual keypad VK are input, the mobile terminal 10 can output a key value consistently by logically estimating a user's actual intention on the basis of a priority value. Accordingly, the recognition rate of a touch input can be improved.

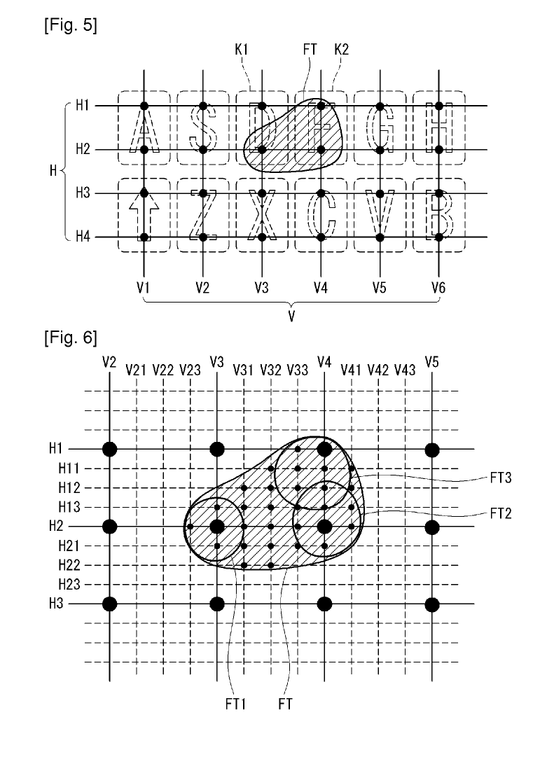

As shown in FIG. 5, a closed touch curve FT with respect to a user's touch input may be formed in a region including specific real nodes (i.e., intersections of H and V). The real nodes (i.e., the intersections of H and V) may be formed by the crossing of horizontal patterns H and vertical patterns V on the touch screen 100. A user's touch, as shown in FIG. 5, may be made over both the D key K1 and the F key K2, and in this case, electrical signals may be generated by the touch from the real nodes of the intersections of H1 and V4, H2 and V3 and H2 and V4.

As shown in FIG. 6, it may be assumed that virtual nodes (intersections of V21 to V43 and H11 to H23) exist between the real nodes (the intersections of H and V). The virtual nodes (the intersections of V21 to V43 and H11 to H23) are positioned in spaces between the real nodes (the intersections of H and V), thereby allowing the shape of a touched region to be specifically determined. For example, at a first real node (an intersection of V3 and V2), the strength of a touch may be calculated as affecting the region of a first closed touch curve FT1 depending on the intensity of the touch associated with the pressure applied by the user and a touch lasting time. That is, considering the intensity of the touch at the first real node (the intersection of V3 and H2), the touch input may be calculated as affecting the range of the first closed touch curve FT1 including first, second, third and fourth virtual nodes (an intersection of V3 and H13, an intersection of V23 and H2, an intersection of V3 and H21 and an intersection of V31 and H2). In the above manner, touch inputs on second and third real nodes (an intersection of V4 and H1 and an intersection of V4 and H2) may be calculated as affecting second and third closed touch curve FT2 and FT3.

In the spaces between the first, second and third closed touch curves FT1, FT2 and FT3, the intensity distribution of the touch may be determined in due consideration of the course of the touch strength with respect to a relative location of the first, second and third real nodes (the intersection of V3 and V2, the intersection of V4 and H1, and the intersection of V4 and H2).

In a section where the second and third closed touch curves FT2 and FT3 overlap each other, the touch inputs on the second real node (the intersection of V3 and H2) and on the third real node (the intersection of V4 and H2) overlap each other, and thus the touch intensity may be calculated to be high.

Consequently, the closed touch curve FT may be calculated by using the first, second and third real nodes (the intersection of V3 and H2, the intersection of V4 and H1, and the intersection of V4 and H2) and the virtual nodes therebetween (the intersections of V21 to V43 and the H11 to H23).

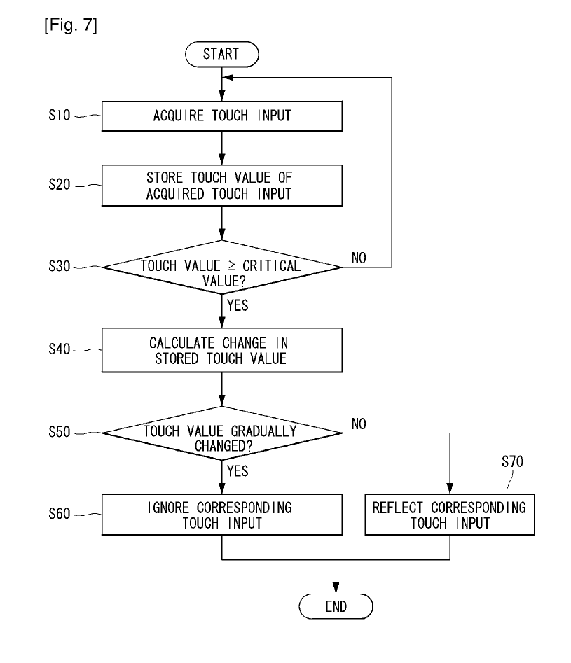

FIG. 7 is a flowchart illustrating the operational process of the mobile terminal of FIG. 1.

As shown therein, the controller 40 (see FIG. 2) of the mobile terminal 10 according to an exemplary embodiment of the present invention may allow for the acquisition of a touch input in operation S10.

The touch input may refer to a user's touch on the touch screen 100. The user may make a desired input by touching the touch screen 100 with his hand, a stylus, or the like.

When the user touches the touch screen 100, the controller 40, as described above, generates a touch input signal including information regarding a touched portion or the like.

When the touch input is acquired, touch values of the acquired touch input may be stored in operation S20.

The touch input signal may contain touch values such as coordinates of the touched portion. For example, the touch values may include information regarding the coordinates of the touched portion, a time point when the touch occurs, or the like.

The touch values may be stored sequentially in order of time. For example, this means that the process in which the touched region gradually expands from a specific point where the touch initially occurs may be sequentially stored together with time information.

In operation S30, it may be determined whether the touch values are equal to or greater than a critical value.

In general, a touch on one point of the touch screen 100 is made such that a touch region gradually and sequentially expands. A detailed description thereof will now be made. Typically, a finger or a stylus used to touch the touch screen 100 has a rounded tip. Thus, when a user touches the touch screen 100 with his finger or a stylus, the very end of the tip initially comes into contact with a specific spot on the touch screen 100 and then, the surrounding portion of the very end of the tip comes into contact with the touch screen 100. Furthermore, a portion of the touch screen 100, determined to be touched due to pressure transmitted from the touched portion or a variation in capacitance even if there is no direct contact with the finger or the stylus, may be gradually increased. The progress of the touch on the touch screen 100 may be understood as an increase in touch intensity. That is, as the touch proceeds on the touch screen 100, the real nodes generating touch signals may increase in number, the virtual nodes may increase in number, or the touched area may include. This may be considered to be an increase in the intensity of touch signals.

The critical value may be a reference to determine whether or not a stored touch input is valid. That is, the critical value may be a reference value to determine which of corresponding touch signals is a valid touch signal.

The critical value may be determined in due consideration of a specific number of real nodes being touched. Namely, in the case in which it is determined that a specific number or more of real nodes are touched during a touch, the controller 40 (see FIG. 20) may determine the touch to be valid.

The critical value may be determined in due consideration of the number of virtual nodes. For example, when the number of virtual nodes that may be determined to be touched is greater than a specific number, it may be determined that the touch value exceed the critical value.

The critical value may be determined in due consideration of a touched area. For example, if the area of the inside area of the closed touch curve FT (see FIG. 6) formed based on the real nodes and/or the virtual nodes is greater than a specific area, it may be determined that the touch value exceeds the critical value.

When the touch value is equal to or greater than the critical value, a change in the stored touch value may be calculated in operation S40.

As described above, the touch value may contain the coordinates of a touch and time information thereof. Thus, the controller 40 (see FIG. 2) may examine a change in touch input before the touch value reaches the critical value. This means that the increment rate of the touch intensity of the valid touch signal exceeding the critical value, before the touch value exceeds the critical value, may be brought into consideration. In the case in which a touch value is determined to reach a critical value when ten nodes have been touched, the controller 40 (see FIG. 2) may calculate a change in touch intensity in the following manner. When an input representing that ten nodes have been touched is made, the controller 40 (see FIG. 2) may calculate the increment rate on the basis of each time when nine nodes are touched.

The increment rate refers to a change in the touch value over time, and may be different according to the kind of touch input. Based on the increment rate, a user's intentional touch may be distinguished from an unintentional touch.

As for an intentional touch, a touch value may increase at a high rate over time. That is, the number or area of nodes touched centering on a specific spot may increase within a very short period of time. For example, if a user intentionally touches a specific spot on the touch screen 100, the number of nodes being touched may rapidly increase from the time point when the first node of ten nodes, the critical value, is touched to the time point when the tenth node is touched.

As for an unintentional touch, a touch value may increase slowly (gradually) over time. That is, the number and/or area of nodes being touched may increase relatively slowly. For example, if a user unintentionally touches the touch screen 100 with his palm while touching a specific spot on the touch screen 10 with his finger, the number of nodes being touched by the palm may increase slowly from the time point when the first node of ten nodes, the critical value, is touched to the time point when the tenth node is touched. Such a phenomenon can be explained upon an observation on a user's grab for the mobile terminal 100, and this will be described later in more detail.

When it is determined that the touch value has gradually changed in operation S50 (YES), the corresponding input may be ignored in operation S60.

If the touch value has changed gradually, there is a strong possibility that the corresponding touch input is a user's unintentional touch as describe above. Thus, the corresponding touch input may be ignored so as to prevent the unintended touch from affecting the function of the mobile terminal 10.

However, when it is determined that the touch value has not gradually changed in operation S50 (NO), the corresponding touch input may be reflected in operation S70.

If the touch value has rapidly changed, there is a strong possibility that the corresponding touch input is a user's intentional touch input as described. Thus, the touch input may be reflected in the operation of the mobile terminal 10. That is, by the corresponding touch input, a display of the touch screen may be shifted or a specific function of the mobile terminal 10 may be executed.

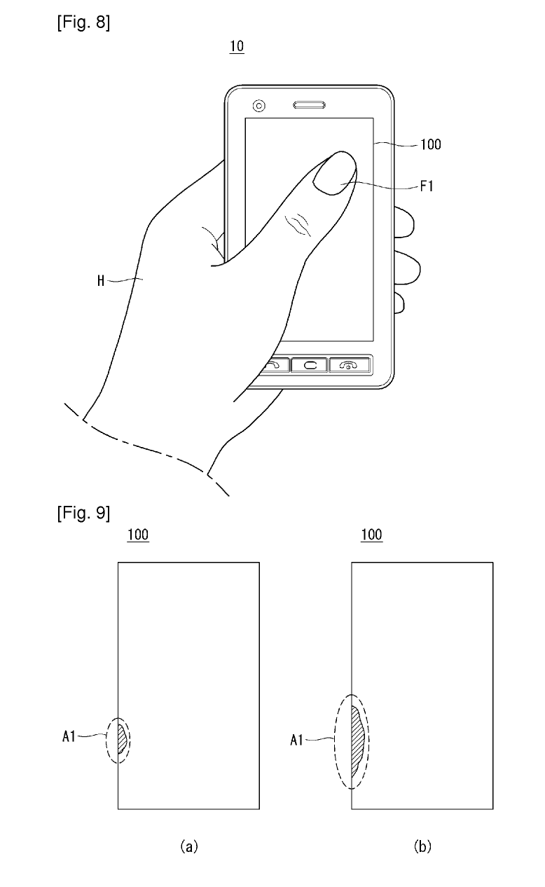

FIG. 8 is a view illustrating a user's touch on the mobile terminal of FIG. 1.

As shown therein, a user may touch the touch screen 100 while holding the mobile terminal 10 according to an exemplary embodiment of the present invention with his one hand.

A user may perform a touch operation while holding the body of the mobile terminal 10 with his left or right hand. Hereinafter, this holding will be referred to as a one-hand grab? There may be a situation where the user is unable to manipulate the mobile terminal 100 with two hands, such as when the user is moving or holding a bag with one hand. In such cases, the one-hand grab may frequently occur.

In the state of a one-hand grab, the user may need to touch a specific spot on the touch screen 100 with a first finger (the thumb) F1. Since each finger has at least one joint, the tip of the first finger F1 is able to touch a spot desired by the user. However, after or before the touch on the desired spot, another part of the hand H may unintentionally touch the touch screen 100. For example, a portion of the palm may come into contact with the touch screen 100.

When both the first finger F1 and the portion of the palm come into contact with the touch screen 100, the controller 40 (see FIG. 40) may fail to determine which touch is a user's intentional touch. In this case, the two touches may all be ignored or reflected to execute a corresponding function, or a preceding touch of the two touches may be regarded as an intentional touch to execute a corresponding function. This may bring about a result contradictory to the user's intention. However, according to an exemplary embodiment of the present invention, the controller 40 (see FIG. 2) of the mobile terminal 10 can allow the mobile terminal 10 to operate by the user's real intention under the same case as described above.

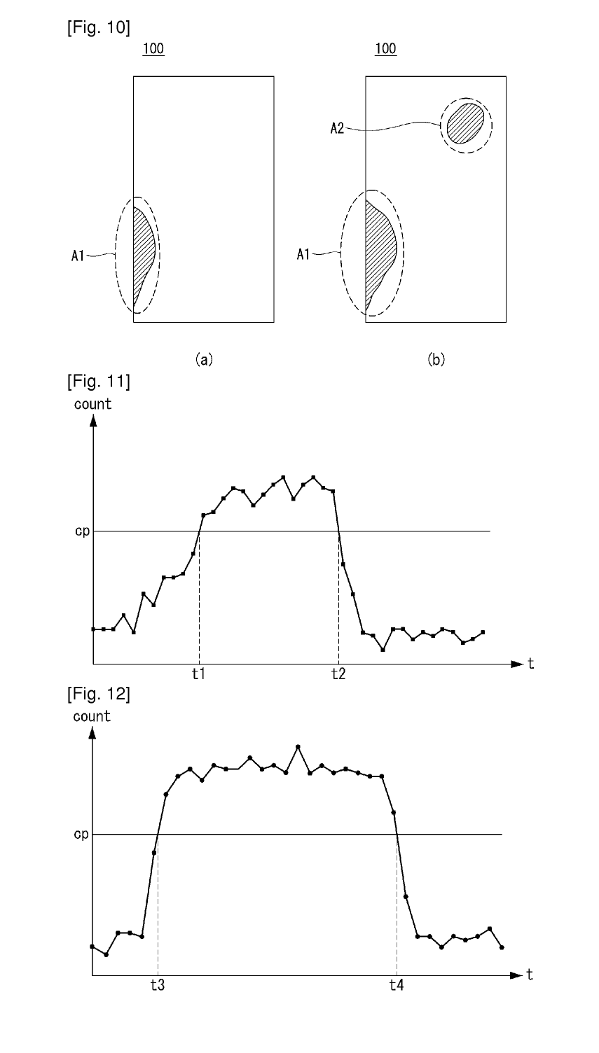

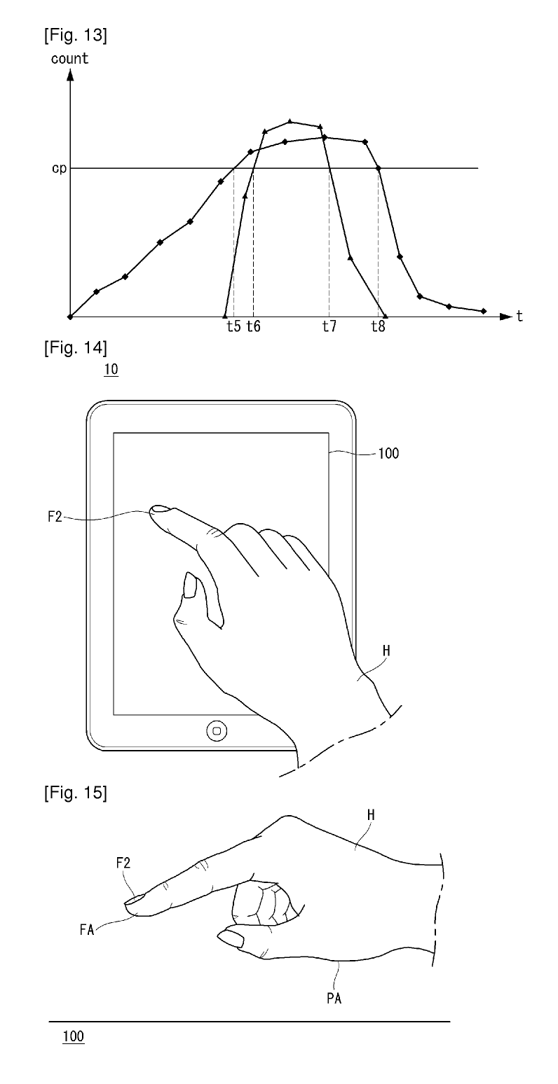

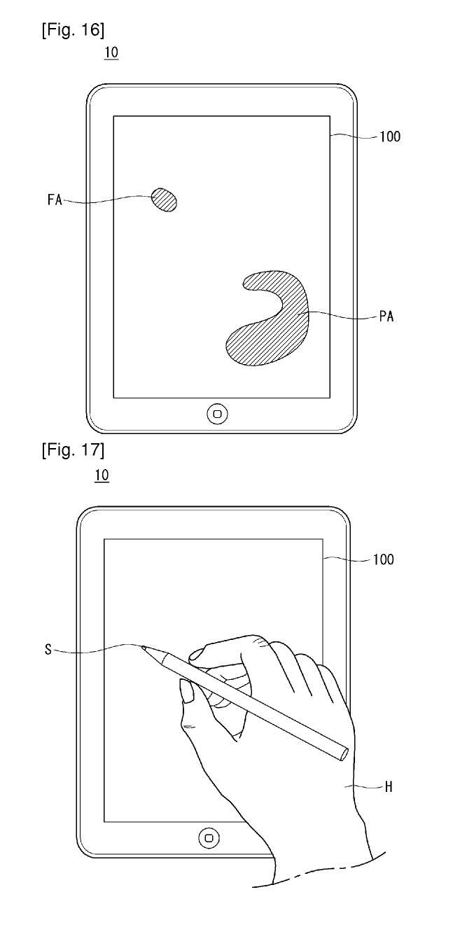

FIGS. 9A through 10B are views illustrating how the touch depicted in FIG. 8 proceeds.

As shown in the drawings, a touch may appear in different patterns according to how a user holds the mobile terminal and/or whether or not a touch is an intentional touch. The progress of a touch is depicted in FIGS. 9A through 10B upon assuming a one-hand grab, in particular, a one-hand grab using the left hand as shown in FIG. 8. Thus, in the case of a one-hand grab using the right hand, a touch may proceed in a bilaterally symmetrical manner to the touch shown in FIGS. 9A through 10B. Furthermore, in some cases, a touch may proceed vertically, rather than horizontally as illustrated. That is, FIGS. 9A through 10B merely illustrate an extremely limited example of various one-hand grabs and are not meant to exclude other examples to which the present invention is applicable.

As shown in FIG. 9A, when a touch is made with the finger in the state of a one-hand grab using the left hand, a first touched region A1 may be generated at the lower left edge of the touch screen 100. The first touched region A1 may be a region corresponding to a touch signal generated as the user's palm comes into contact with the touch screen 100. The first touched region A1 may refer to a real node that is actually touched, a portion expanded from the real node to a virtual node, or a predetermined region other than separated nodes.

As shown in FIGS. 9B and 10A, the first touched region A1 may expand as the user's touch proceeds. That is, this means that as the first finger F1 (see FIG. 8) approaches the touch screen 100 in the state of the one-hand grab, the area of the user's palm coming into contact with the touch screen 100 increases.

As shown in FIG. 10B, a second touched region A2 may be generated at a specific time point. Here, the second touched region A2 corresponds to a touch signal made by the tip of the first finger F1 (see FIG. 8). Meanwhile, the size of the first touched region A1 may be maximized at the time point when the second touched region A2 is generated.

Since the second touched region A2, corresponding to the user's intentional touch, and the first touched region A1 unintentionally touched by the user but gradually expanding from before the generation of the second touched region A2, co-exist, the controller 40 (see FIG. 2) needs to determine which of the touches is the user's intentional touch. In this case, the controller 40 (see FIG. 2) according to an exemplary embodiment of the present invention may determine the user's intentional touch on the basis of a change in the stored touch value before the touch value reaches the critical value. Namely, the controller 40 (See FIG. 2) according to an exemplary embodiment of the present invention may determine the user's intentional touch when an increment rate of the touch intensity over time is greater than a reference increment rate, and thus allow for the execution of a corresponding function.

FIGS. 11 and 12 are graphs showing an increase in touch points according to the progress of the touch shown in FIGS. 9A through 10B.

As shown in the drawings, the controller 40 (see FIG. 2) of the mobile terminal 10, according to an exemplary embodiment of the present invention, may determine an increment rate of touch intensity over time.

In the graph of FIG. 11, the horizontal axis denotes the time while the vertical axis denotes the number of real nodes (intersections of H and V in FIG. 5) generating touch signals made by a user's touch. The number of real nodes (intersections of H and V in FIG. 5) generating a touch signal may correspond to touch intensity. That is, an increase in the number of real nodes (intersections of H and V in FIG. 5) may be considered to be an increase in touch intensity, and a decrease in the number of real nodes (intersections of H and V in FIG. 5) may be considered to be a decrease in touch intensity.

When the user touches a specific point on the touch screen 100, 100, the number of real nodes (intersections of H and V in FIG. 5), namely, the number of touched input nodes, may increase or decrease according to the physical strength and/or area of the finger touching the touch screen 100 as shown in FIG. 11.

Considering the cases of incorrect input and/or operation with respect to the touch screen 100, the controller 40 (see FIG. 2) may determine the touch as a valid touch signal when the number of touched input nodes exceeds the critical value CP. Namely, when the number of touched input nodes is in the range of t1 to t2 of FIG. 11, a first condition to execute a function corresponding to the touch signal is satisfied.

At the time point t1 when the number of touched input nodes exceeds the critical value CP, the controller 40 (see FIG. 2) may examine the increment rate of touch intensity from the moment when a touch input with respect to a specific spot is initiated to the time point t1. That is, after the first condition is satisfied, the controller 40 (see FIG. 2) may determine whether or not a second condition for the execution of the function is satisfied.

The second condition may be associated with whether or not the increment rate of touch intensity is higher than a reference increment rate. A touch input, intended by a user, may have rapidly increasing touch intensity. For example, when the user intentionally touches the touch screen 100 with the finger, the number of touched input nodes generating a touch signal exceeds the critical value within a short period of time.

In the case of the touch depicted in FIG. 1, it can be seen that an increment rate is slow (low) since it takes relatively long time to reach the time point t1. As described above, a touch with a slow increment rate may be a user's unintended touch. Namely, the touch with a slow increment rate may be generated due to an action such as unintended contact between a portion of the palm, other than the finger, and the touch screen 100. Consequently, the controller 40 (FIG. 2) may determine that the touch depicted in FIG. 11 satisfies the first condition while failing to satisfy the second condition. Accordingly, the controller 40 (see FIG. 2) may not execute a function corresponding to the touch.

As described above, the touch intensity may be determined on the basis of the number of real nodes (the intersections of H and V in FIG. 5) generating a touch signal. Furthermore, the touch intensity may be determined on the basis of the number of virtual nodes (the intersections of V21 to V43 and H11 to H23 in FIG. 6) between the real nodes (the intersections of H and V in FIG. 5). Furthermore, the touch intensity may be determined on the basis of the area of the touched region including the real nodes (the intersections of H and V in FIG. 5) and the virtual nodes (the intersections of V21 to V43 and H11 to H23 in FIG. 6).

As shown in FIG. 12, a touch signal corresponding to a touch input may exceed the critical value CP at a time point t3. The time point t3 may be closer to the time point when the touch is initiated than the time point t1. In this case, the increment rate before the time point t3 may be relatively rapid. That is, this means that the touch intensity reaches the critical value CP within a short period of time from the time point when the touch is initiated. Such a touch may be a user's intentional touch input. Accordingly, the controller 40 (see FIG. 2) may execute a function corresponding to the touch input. For example, a signal indicating the user has selected a specific popup window may be output. In contrast, if the touch is determined as the user's unintentional touch as in the touch shown in FIG. 11, the controller 40 (see FIG. 2) ignores the touch input so that no function is executed.

FIG. 13 is a graph showing an increase in touch points according to another exemplary embodiment of the present invention.

As shown in the drawing, there may be a first touch signal reaching the critical value CP at a time point t5, and a second touch signal reaching the critical value CP at a time point t6. That is, a plurality of touch signals may be input at a specific time point. In this case, the controller 40 (see FIG. 2) may select a valid touch signal through the following procedure.

The controller 40 (see FIG. 2) may load data, associated with a touch signal stored in a memory, at a time point t5 when the first touch signal reaches the critical value CP. As can be seen from FIG. 13, the first touch signal has a relatively slow increment rate, and the increment rate of the first touch signal may be slower than a preset reference increment rate. In this case, the controller 40 (see FIG. 2) may ignore the first touch signal. This means that even if the first touch signal exceeds the critical value CP, a function corresponding to the touch may not be executed.

The controller 40 (see FIG. 2) may determine the increment rate of the second touch signal at a time point t6 when the second touch signal reaches the critical value CP. As can be seen from FIG. 13, the second touch signal has a relatively fast (high) increment rate, and the increment rate of the second touch signal may be greater than a preset reference increment rate. Accordingly, the controller 40 (see FIG. 2) may determine that the second touch signal is valid, so that a function corresponding to the second touch signal can be executed. Since a valid touch signal is determined on the basis of the increment rate of the touch intensity, a user's intentional touch may be effectively determined even when a plurality of touches are input.

FIGS. 14 through 16 are views illustrating a touch according to another exemplary embodiment of the present invention.

As shown in FIG. 14, the mobile terminal 10 may be configured in the form of a pad having a relative wide touch screen 100. In this case, when an action of touching a specific spot of the touch screen 100 is taken, another portion of the hand H may touch the touch screen 100.

As shown in FIG. 15 showing the touch of FIG. 14 from the side, an invalid touch point PA corresponding to the palm of the hand H, as well as a valid touch point FA of the second finger F2, may be generated.

As shown in FIG. 16, a touch by the valid touch point FA and a touch by the invalid touch point PA may be generated. Even when a plurality of touches are generated as described above, the controller 40 (see FIG. 2) may effectively determine the valid touch point FA as an intentional touch input. That is, a signal input by the touch of the invalid touch point PA, having high touch intensity due to the wide touched area while increasing in area over a relatively long period of time, may be ignored. Also, a signal input by the valid touch point FA increasing in area within a relatively short period of time may be determined to be valid.

FIGS. 17 through 19 are views illustrating a touch according to still another exemplary embodiment of the present invention.

As shown in FIG. 17, a user may touch the touch screen 100 of the mobile terminal 10 by using a stylus S or the like.

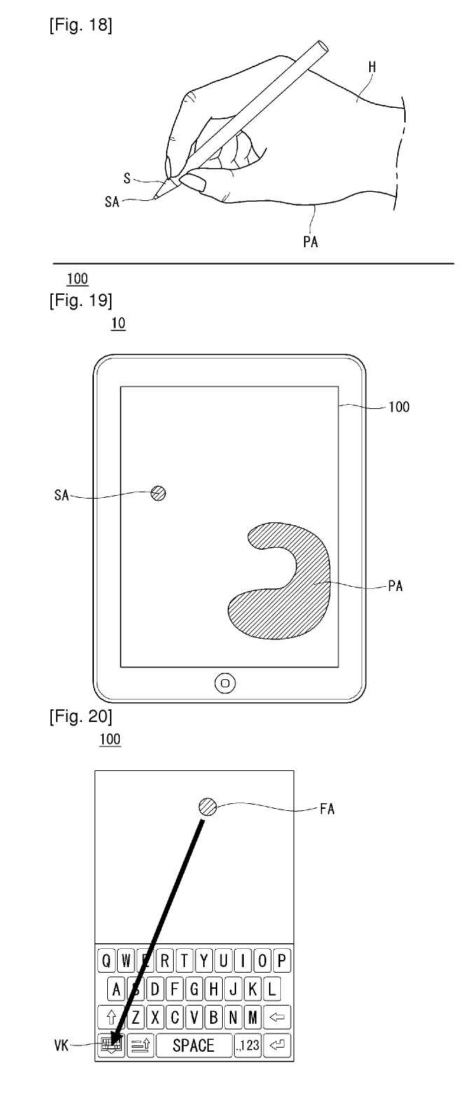

As shown in FIG. 18 showing the touch of FIG. 17 from the side, a touch by a valid touch point SA, the tip of the stylus S, and a touch by an invalid touch point PA corresponding to the palm of the hand H, may be generated at the same time or with a small time difference.

AS shown in FIG. 19, the invalid touch point PA may have a wider area than the valid touch point SA. Furthermore, the invalid touch point PA may touch the touch screen 100 before the valid touch point SA. Even in this case, when the increment rate of the invalid touch point PA is slower than a reference increment rate and the increment rate of the valid touch point SA is faster than the reference increment rate SA, the controller 40 (FIG. 2) may execute a corresponding function on the basis of the valid touch point SA.

FIG. 20 is a view illustrating a touch according to another exemplary embodiment of the present invention.

As shown in the drawing, the controller 40 (see FIG. 2) according to another exemplary embodiment of the present invention may perform an input intended by a user by tracking a valid touch input.

A user may perform various touch gesture inputs by using a valid touch point FA. For example, a letter input may be performed mainly on the upper part of the touch screen 100, which is a region allowing for the letter input using a touch gesture. According to circumstances, a touch gesture for a letter input may be performed on a specific key VK on a QWERTY keypad. In this case, according to the related art, it may be determined that a touch on the specific key VK has been performed. However, according to another exemplary embodiment of the present invention, the controller 40 (see FIG. 2) may track the path of the valid touch point FA without determining that the specific key VK is pressed, until the user actually releases the touch. That is, even when the touch is made outside the touch gesture input region, a valid touch gesture input may be performed.

While the present invention has been particularly shown and described with reference to exemplary embodiments thereof, it will be understood by those of ordinary skill in the art that various changes in form and details may be made therein without departing from the spirit and scope of the present invention as defined by the following claims.

1-21. (canceled)

22. A mobile terminal comprising:
a touch screen acquiring a touch signal regarding at least one region; and
a controller selectively executing a function corresponding to a valid touch signal of the acquired touch signal, having a touch intensity equal to or greater than a preset critical value, on the basis of an increment rate of the touch intensity of the valid touch signal.

23. The mobile terminal of claim 22, wherein the controller executes the function on the basis of an increment rate of the touch intensity over time.

24. The mobile terminal of claim 23, wherein the controller executes the function when the increment rate over time more rapidly increases or decreases than a set reference increment rate.

25. The mobile terminal of claim 22, wherein the controller executes the function on the basis of the increment rate before the valid touch signal reaches the critical value.

26. The mobile terminal of claim 22, wherein the touch screen includes at least one touch input node generating the touch signal corresponding to a touch, and
the touch intensity is in proportion to the number of touch input nodes generating the touch signal.

27. The mobile terminal of claim 22, wherein the touch screen includes at least one touch input node generating the touch signal corresponding to a touch, and
the touch intensity is in proportion to at least one of the number of touch input nodes generating the touch signal and the number of virtual touch input nodes adjacent to the touch input node generating the touch signal.

28. The mobile terminal of claim 22, wherein the touch screen includes one or more touch input nodes generating the touch signal corresponding to a touch, and
the touch intensity is in proportion to an area of a touched region formed by at least one of the touch input node generating the touch signal and a virtual touch input node adjacent to the touch input node generating the touch signal.

29. The mobile terminal of claim 28, wherein the touched region is a closed curve including at least one of the touch input node and the virtual touch input node.

30. The mobile terminal of claim 22, further comprising a memory storing data of the acquired touch signal over time,
wherein the controller determines the increment rate by loading the data stored in the memory when the acquired touch signal has touch intensity equal to or greater than a set critical value.

31. The mobile terminal of claim 22, wherein the controller terminates the function being executed, when the touch intensity is less than the set critical value.

32. A method of controlling a mobile terminal, the method comprising:
acquiring a touch signal regarding at least one region; and
executing a function corresponding to a valid touch signal of the acquired touch signal, the valid touch signal having a touch intensity equal to or greater than a set critical value,
wherein, in the execution of the function, the function is selectively executed on the basis of an increment rate of the touch strength of the valid touch signal.

33. The method of claim 32, wherein, in the execution of the function, the function is executed on the basis of an increment rate of the touch strength over time.

34. The method of claim 33, wherein, in the execution of the function, the function is executed when the increment rate over time more rapidly increases or decreases than a set reference increment rate.

35. The method of claim 32, wherein, in the execution of the function, the function is executed on the basis of the increment rate before the valid touch signal reaches the critical value.

36. The method of claim 32, wherein, in the execution of the function, the touch intensity is in proportion to the number of touch input nodes generating the touch signal.

37. The method of claim 32, wherein, in the execution of the function, the touch strength is in proportion to at least one of the number of touch input nodes generating the touch signal and the number of virtual touch input nodes adjacent to the touch input node generating the touch signal.

38. The method of claim 32, wherein, in the execution of the function, the touch intensity is in proportion to an area of a touched region formed by at least one of the touch input node generating the touch signal and a virtual touch input node adjacent to the touch input node generating the touch signal.

39. The method of claim 32, further comprising storing the acquired touch signal and time data regarding time when the touch signal is generated.

40. A method of controlling a mobile terminal, the method comprising:
acquiring first and second touch signals regarding different positions; and
outputting, as a valid touch signal, one of a touch signal of the first and second touch signals, having touch intensity equal to or greater than a set critical value while an increment rate of the touch strength is equal to or greater than a reference increment rate.

41. The method of claim 40, wherein the outputting of the touch signal comprises executing a function corresponding to the valid touch signal.
